(19) United States
(12) Patent Application Publication
(10) Pub. No.: US 2010/0295284 A1
(43) Pub. Date: Nov. 25, 2010

(54) APPARATUS FOR ACTIVATING A SAFETY DEVICE, PARTICULARLY OCCUPANT PROTECTING DEVICE IN A VEHICLE

(76) Inventors: Horst Mannebach, Munstermaifeld (DE); Daniel Thull, Saarbrucken (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/735,178

(22) PCT Filed: Dec. 15, 2008
(86) PCT No.: PCT/EP2008/010644

§ 371 Date: Aug. 10, 2010

(30) Foreign Application Priority Data
Dec. 21, 2007 (DE) 10 2007 062 080.4

(51) Int. Cl. B60R 21/02

(52) U.S. Cl. 280/748

(57) ABSTRACT

The invention relates to an apparatus (1) for activating a safety device, particularly an occupant protection device in a vehicle, the apparatus (1) comprising an actuator (10) and an energy accumulator (12), characterized in that the apparatus (1) comprises a permanent magnet (14) that blocks the release of the energy stored in the energy accumulator (12) in a starting state of the apparatus (1) and that the magnetic flow created by the permanent magnet (14) can be temporarily changed by the actuator (10) in such a way that the energy stored in the energy accumulator (12) can be released for activating the safety device.

The invention relates to an apparatus for activating a safety device, particularly an occupant protection device in a vehicle. Such devices are used, for example, to activate safety systems, such as retractable rollover bars, pop-up engine hoods, or active head rests, in a motor vehicle equipped with a so-called pre-crash system, for the purpose of enhancing the protection of the occupants of a motor vehicle in the event of a collision.

Such devices need electrical energy to operate, so that a reliable activation of the safety system can be guaranteed. For this reason they exhibit an electrical load that cannot be ignored. In order to reduce the load, the device may have a capacitor in which the electrical energy is stored and which is discharged, on demand, in a short period of time, that is, at a comparatively high output. The electrical energy accumulator has to have been previously charged; and it must be guaranteed that the energy accumulator has always stored the energy required for activating the safety system. This requires that in operation the electrical energy supply must be continuous.

DE 197 22 013 A1 discloses a magneto-mechanical power system, wherein the floor of a cylindrical soft iron vessel has one or more permanent magnets that support a flux guiding plate that forms a shunt air gap with respect to the wall of the soft iron vessel and has a neck that has a small diameter and is offset in the manner of a step. The face side of the neck lies in a common plane with the edge of the soft iron vessel. The neck of the flux guiding plate is enveloped by a current coil that is connected to a current source. A magnetically adhering pole disk lies on the neck and the edge of the soft iron vessel. The pole disk is used alone or with a plunger, attached to said pole disk, and a spring to activate the attached system.

DE 1 768 717 U discloses a holding magnet, in which an armature is connected to a lever, which is subject to the action of a restoring spring, such that it can be rotated about a point that lies in the pole area of the magnet when the armature is attracted.

DE P 21278 D AZ discloses a magnetic brake for electric motors; and the U.S. Pat. No. 2,656,026 discloses a brake with a permanent magnet.

DE 203 15 442 U1 discloses an arrangement for generating a free magnetic field, which can be switched off, has a core, at least one permanent magnet surrounding the core, and at least one annular coil, which surrounds the permanent magnet and which can be supplied with current in such a manner that a magnetic field, which intensifies the magnetic field of the permanent magnet, is generated.

The invention is based on the object of providing a device that overcomes the disadvantages of the prior art, in particular guarantees a reliable activation of the safety system, when both the electrical load and the energy consumption are low.

This object is achieved by the device defined in claim 1. Special design variants of the invention are defined in the dependent claims.

In one design variant the device exhibits not only the actuator and the energy accumulator, but also a permanent magnet, which blocks the release of the energy, stored in the energy accumulator, in the initial state of the device. The advantageous feature in this design is that the permanent magnet does not need an electrical energy supply either in operation or during activation. As a result, the device exhibits a low energy consumption; and even on activation of the safety system, the power consumption of the device is very low. In addition, it is advantageous that, owing to the permanent magnet, relatively high forces can be provided in order to block the energy stored in the energy accumulator.

The magnetic flux, generated by the permanent magnet, can be changed at least temporarily, that is, on activation of the safety system, by the actuator in such a way that the energy stored in the energy accumulator can be released. In this case, the actuator itself can exhibit a comparatively low electrical load, because only the blocking effect of the permanent magnet has to be eliminated.

In one design variant the energy accumulator is a mechanical energy accumulator, for example, a resiliently deformable and, thus, energy-storing element. In principle, the energy-storing deformation of the mechanical energy accumulator can take place in a controllable and motor driven manner, for example, in an initialization process, with which the device is moved into its initial state. In one design variant the deformation of the mechanical energy accumulator takes place manually so that no electrical energy is required even for charging the energy accumulator. In one design variant the mechanical energy accumulator is designed as a spring element, for example, as a helical spring, a cup spring, or the like.

In one design variant the energy accumulator acts on an element of the device; in particular, the energy accumulator is in contact with an element of the device, through which the magnetic flux, which is generated by the permanent magnet, flows at least in certain sections. Owing to the magnetic flux, the magnetic attraction forces act on the element, which consequently blocks the release of the energy stored in the energy accumulator.

One design variant provides that in the initial state of the device the magnetic flux, generated by the permanent magnet, flows by way of a magnetic yoke, which blocks the energy stored in the energy accumulator. In this case the magnetic flux flows preferably without an air gap, as a result of which a high blocking force can be generated with the given permanent magnet.

In order to activate the safety system, the energy stored in the energy accumulator is released. To this end an actuator can be provided that reduces the magnetic flux generated by the permanent magnet, for example, by introducing an air gap or by enlarging an existing air gap. In this way the magnetic force on the element, which blocks the energy stored in the energy accumulator, can be reduced enough so that the energy for activating the safety system is released. This step can be carried out, for example, by means of an electromechanically movable armature, a piezoelectric actuator, a magneto-restrictive actuator, or the like.

In one preferred design variant the actuator is formed by an electromagnet. When the electromagnet is supplied with current, the magnetic flux, generated by the permanent magnet, can be changed at least temporarily and locally in such a way that the energy, which is stored in the energy accumulator and which serves to activate the safety system, can be released. In this case it is especially advantageous that the only requirement for activation is a comparatively small current and consequently a low electric power. This feature is all the more important if one takes into consideration the circumstance that in many applications a plurality of such safety systems are activated at more or less the same time, so that the electric power of several devices of the invention adds up for the vehicle electrical system.

The magnetic flux, generated by supplying current to the electromagnet, is superposed at least in certain sections with the magnetic flux of the permanent magnet. In this case, when the electromagnet is supplied with current, the direction of the current is chosen in such a way that in the area of a magnetic yoke, which blocks the energy stored in the energy accumulator, [the magnetic flux] is reduced such that the resulting magnetic force is less than the force generated by the energy accumulator, so that the energy stored in the energy accumulator is released in order to activate the safety system. In one design variant the magnetic flux through an element of the device, on which the energy accumulator acts, can be reduced at least temporarily by supplying current to the electromagnet.

In one design variant an actuating element is movably mounted in the device. After releasing the energy of the energy accumulator, the actuating element activates the safety system by a movement relative to the device. In one design variant the actuating element executes at least in certain sections, preferably as a whole, a linear movement. In one design variant the device also has a stop for the relative movement of the actuating element, so that even after activating the safety system, the actuating element is in a defined position. Preferably in the initial position the actuating element is traversed by the magnetic flux that is generated by the permanent magnet. The actuating element can be reset, preferably manually.

In one design variant, the safety system can be activated only indirectly by the device according to the invention. For this purpose the device acts on a release mechanism of the safety system. For example, the safety system in turn can be prestressed with a mechanical energy accumulator, for example, a spring element. In this case the triggering of the safety system is blocked by a blocking device. The device according to the invention acts on the blocking device and activates the safety system in that the blocking device is deactivated and, thus, the safety system is triggered.

In one design variant the device can be reset, following activation, into the initial position. This action can be performed preferably manually, either at the inventive device itself, at the release mechanism of the safety system, and/or at the safety system. Preferably, the device according to the invention is mechanically coupled with the safety system in such a way that owing to a resetting movement of the safety system, for example, by sliding back an activated head rest, the device can be reset into its initial position and then assume again a stable initial state because of the automatically ensuing closing of the magnetic circuit.

Other advantages, features, and details of the invention are apparent from the dependent claims and the following description, in which one embodiment is described in detail with reference to the drawings. The features indicated in the claims and the description can be essential for the invention either independently by themselves or in any combination.

FIG. 1 shows a top plan view of a first embodiment of a device according to the invention,

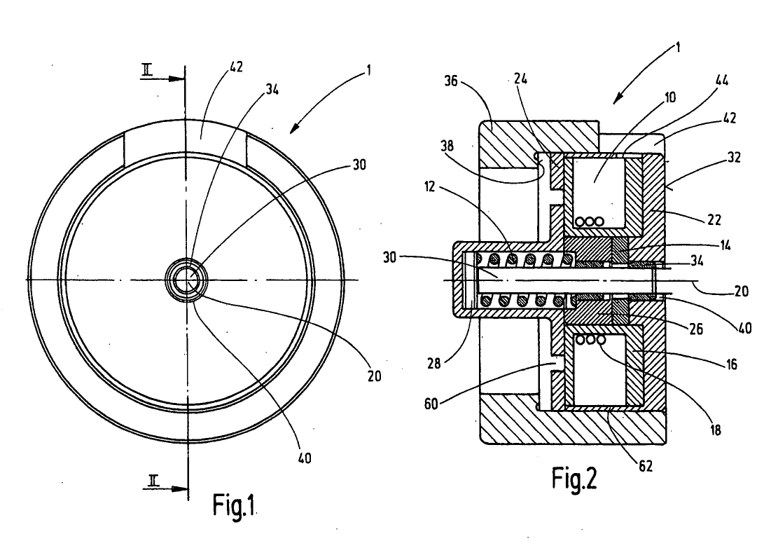

FIG. 2 shows a sectional view of the first embodiment from FIG. 1 along II-II,

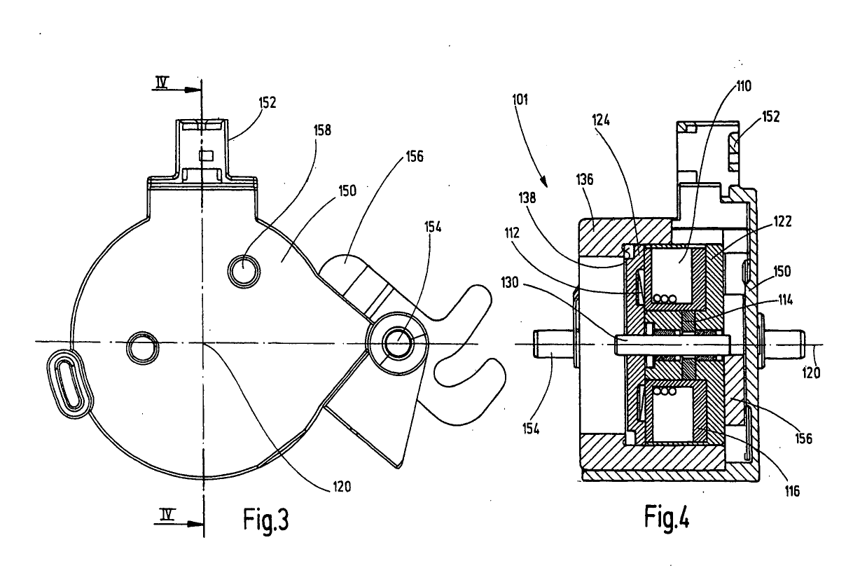

FIG. 3 shows a top plan view of a second embodiment of a device according to the invention, and

FIG. 4 shows a sectional view of the first embodiment from FIG. 3 along IV-IV.

FIG. 1 shows a top plan view of a first embodiment of a device 1 according to the invention for activating a safety system, in particular an occupant protection system in a vehicle. FIG. 2 is a sectional view of the first embodiment from FIG. 1 along II-II.

The device 1 has an actuator 10, an energy accumulator 12, and a permanent magnet 14. The actuator 10 is formed by an electromagnet, which has a coil former 16, on which at least one winding 18 is wound about a longitudinal axis 20 of the device 1. The coil former 16 can be made of a material that does not conduct the magnetic flux or conducts it only poorly. The electromagnet is integrated into a cup-like base body 22, which is made of a material that readily conducts the magnetic flux, just like an actuating element 24, which closes the base body 22 with the electromagnet.

On a radially internal side facing the longitudinal axis 20, the permanent magnet 14 is mounted on a pin-like continuation of the base body 22. The permanent magnet is configured in the shape of a ring with a central port and is polarized axially in the direction of the longitudinal axis 20. In the direction of the actuating element 24, the permanent magnet 14 is connected to a ring element 26, which readily conducts the magnetic flux. On the radial inside, the ring element 26 has a preferably annular shoulder for the contact with the energy accumulator 12, which is formed by a helical spring. With the opposite end the energy accumulator 12 is braced directly or by means of a disk 28 against the actuating element 24, which is configured in the shape of a hat in the illustrated cross section and forms together with the ring element 26 an essentially cylindrical cavity for the accommodation of the energy accumulator 12.

Inside the cavity defined by the actuating element 24, there is a plunger 30, which is connected to the disk 28 and which is preferably cylindrical, at least in certain sections, and which extends preferably concentrically in the direction of the longitudinal axis 20 and which emerges from the base body 22 on the frontal area 32 of the device 1 that faces the base body 22. The length of the plunger 30 that projects beyond the frontal area 32 of the base body 22 and/or the device 1 is smaller than or equal to the maximum stroke of the actuating element 24. The plunger 30 is movably mounted in the device 1 by means of two sliding bearings 34 that are disposed in the area of the actuator 10 and are axially set apart from each other.

In the initial state of the device 1 that is illustrated in FIG. 2, the actuating element 24 is held in contact with the base body 22 and/or the ring element 16 by the permanent magnet 14 and in this way blocks the release of the energy stored in the energy accumulator 12. As a result, the permanent magnet 14 generates a magnetic flux that flows starting from the permanent magnet 14 in the axial direction, in relation to the longitudinal axis 20, over the ring element 26 into the actuating element 24 and then in the radial direction over the flange-like portion of the actuating element 24 and back in the axial and then radial direction over the base body 22 to the permanent magnet 14.

Owing to the supply of current to the winding 18 of the actuator 10, the magnetic flux is reduced, in particular, in the area of the flange-like portion of the actuating element 24, in such a way that the holding force in relation to the spring force, generated by the energy accumulator 12, is no longer adequate enough; and the energy accumulator 12 causes the actuating element 24 to be moved away from the permanent magnet 14 in the direction of the longitudinal axis 20. After a stroke of, for example, a few mm, the flange-like section of the actuating element 24 comes to rest against a stop 38, which is formed by a housing element 36 and which has the shape of a ring in the embodiment.

The device 1 has ventilation ports for the volume that grows larger owing to the movement of the actuating element 24, in order to enable a high acceleration of the actuating element 24. For this purpose the illustrated embodiment shows that the flange-like portion of the actuating element 24 has at least one borehole 60, preferably a plurality of boreholes 60, that can be spaced, for example, equidistant apart on a circular line that runs concentric in relation to the longitudinal axis 20.

The only requirement is that the winding 18 be briefly supplied with current, since the magnetic holding force decreases significantly as soon as the actuating element 24 rises from the base body 22 and/or the ring element 26. In contrast, the force of the energy accumulator 12 has at least a more or less constant effect within the stroke that is comparatively small compared to the axial length of the energy accumulator 12. This feature guarantees a very large acceleration of the actuating element 24 that results in a very short switching time of, for example, less than 5 ms, preferably less than 2 ms and even more preferred less than 1 ms, until the actuating element 24 rests against the stop 38. In this state the pin-like tapered end section of the plunger 30 vanishes in the borehole 40 in such a way that its end does not project beyond the frontal area 32. Owing to this retraction of the plunger 30, the safety system can be activated.

Preferably, the geometry and/or the material of the base body 22 is selected such that at least one section of the base body 22, preferably that section of the base body 22 that borders the actuating element 24, is in a state of magnetic saturation due to the magnetic flux generated by the permanent magnet. In the embodiment, the base body 22 has an annular section 62, which is constructed so as to form one piece with a plate-shaped section forming the frontal area 32. In the initial state that is shown, this annular section is adjacent to the actuating element 24. The thickness of the annular section 62 is chosen such that the annular section 62 is in a state of magnetic saturation. The result is that the switching behavior is optimized even more; in particular, the gradient of the magnetic holding force is increased as a function of the distance of the actuating element 24 from the base body 22.

Preferably, the geometry and/or the material of the base body 22 and/or the actuating element 24 is/are selected so that especially when the safety system is activated, the electrical or magnetic losses are reduced. In particular, the eddy currents in the device 1 are reduced or suppressed. For this purpose the annular section 62 of the base body 22 can have at least one slit, in particular at least one slit running parallel to the longitudinal axis; and/or the actuating element 24, in particular, the flange-like section of the actuating element 24, can have at least one slit, in particular, a slit that runs radially in relation to the longitudinal axis 20.

Radially on the exterior, the housing element 36, which can be made of a material that does not conduct the magnetic flux and is made of a plastic synthetic material or aluminum in the embodiment, exhibits in the radial direction a port 42, which extends as a circular segment through an angle of about 45 deg. and which corresponds with another port 44 in the base body 22 and is used to guide through the connecting lines for the winding 18.

FIG. 3 is a top plan view of a second embodiment of a device 101 according to the invention; and FIG. 4 is a sectional view of the second embodiment of the device 101 along IV-IV from FIG. 3. In addition to the first embodiment, the second embodiment is integrated into a housing shell 150 that forms a connector nipple 152, preferably as one piece, for an electrical screw-in or plug-in connection of the device 101, in particular, the actuator 110. To the extent that the second embodiment of the device 101 is in conformity with the first embodiment 1 from FIGS. 1 and 2, reference is made to the description of its figures.

In contrast to the first embodiment, the device 101 has a plate as the actuating element 124. This plate has a borehole, which is located in the middle relative to the longitudinal axis 120 and is intended for the passage of the plunger 130. The edge of the actuating element 124 has externally an annular shoulder, which comes to rest against the stop 138 of the housing element 136, when the energy stored in the energy accumulator 112 is released. In the second embodiment the energy accumulator 112 is designed as a cup spring and with its radially inner end is in contact with the coil former 116 and with its radially outer end is in contact with an annular groove on the frontal area of the actuating element 124 that faces the coil former 116.

The housing shell 150 has eccentrically an axis 154, which projects axially along the longitudinal axis 120 beyond both sides of the housing shell 150. The housing shell 150 contains a swivel-type lock 156, which in the illustrated design state is held by spring force in radial abutment against the end of the plunger 130 that projects beyond the base body 122. By activating the actuator 110, that is, by supplying current to the winding of the electromagnet, the magnetic flux, generated by the permanent magnet 114, through the actuating element 124 is reduced in such a way that the actuating element 124 rises subject to the effect of the energy accumulator 112; and the plunger 130, which is movably coupled at least axially with the actuating element 124 and which is connected preferably to the actuating element 124, is moved into the base body 122.

Consequently, the swivel path for the swivel-type lock 156 is released and, as a result, the safety system is activated. For this purpose the swivel-type lock 156 swivels in such a way that it can release, for example, a spring force-loaded bolt, through the movement of which, for example, a head rest is moved in the direction of the head of an occupant of a vehicle, thus decreasing the risk of injury for the occupant in the event of a collision. When the swivel-type lock 156 is swiveled back by hand and then when the energy accumulator 112 is stressed, for example, by moving the actuating element 124 again into latching contact with the base body 122 by way of the port 158 in the housing shell 150, the device can be reset.

1. An apparatus (1) for activating a safety device, particularly an occupant protection device in a vehicle, wherein the apparatus (1) has an actuator (10) and an energy accumulator (12), characterized in that the apparatus (1) has a permanent magnet (14), which blocks the release of the energy, stored in the energy accumulator (12), in the initial state of the apparatus (1), and that the magnetic flux, generated by the permanent magnet (14), can be changed at least temporarily by the actuator (10) in such a way that the energy, stored in the energy accumulator (12), can be released, in order to activate the safety system.

2. The device (1), according to claim 1, characterized in that the energy accumulator (12) is a mechanical energy accumulator, in particular, a resiliently deformable and, thus, energy-storing element.

3. The device (1), according to claim 1, characterized in that the energy accumulator (12) acts on an element of the device (1); in particular, is in contact with an element of the device (1), through which the magnetic flux, which is generated by the permanent magnet (14), flows at least in certain sections.

4. The device (1), according to claim 1, characterized in that in the initial state of the device (1) the magnetic flux, generated by the permanent magnet (14), flows by way of a magnetic yoke, which blocks the energy stored in the energy accumulator (12).

5. The device (1), according to claim 1, characterized in that the actuator (10) is an electromagnet, which when supplied with current can change at least temporarily the magnetic flux, generated by the permanent magnet (14), in such a way that the energy, which is stored in the energy accumulator (12) and which serves to activate the safety system, can be released.

6. The device (1), according to claim 5, characterized in that the magnetic flux through an element of the device (1), on which the energy accumulator (12) acts, can be temporarily reduced by supplying current to the electromagnet.

7. The device (1), according to claim 1, characterized in that the actuating element (24) is movably mounted in the device (1); and that, after releasing the energy of the energy accumulator (12), the actuating element (24) activates the safety system by a movement relative to the device (1).

8. The device (1), according to claim 7, characterized in that the device (1) has ventilation ports for the volume that grows larger owing to the movement of the actuating element (24), in order to enable a high acceleration of the actuating element (24).

9. The device (1), according to claim 7, characterized in that the device (1) has a stop for the relative movement of the actuating element (24).

10. The device (1), according to claim 1, characterized in that the safety system can be activated indirectly by the device (1), in that the device (1) acts on a release mechanism of the safety system.

11. The device (1), according to claim 1, characterized in that following activation, the device (1) can be reset, in particular, can be manually reset, into the initial state.

12. The device (1), according to claim 1, characterized in that the actuator (10) is formed by an electromagnet, which is integrated into a pot-like base body (22), which is made of a material that readily conducts the magnetic flux, and that the geometry and/or the material of the base body (22) is selected such that at least one section of the base body (22) is in a state of magnetic saturation due to the magnetic flux generated by the permanent magnet (14).
